(19) United States
(12) Patent Application Publication
(10) Pub. No.: US 2004/0245428 A1
(43) Pub. Date: Dec. 9, 2004

(54) Pin mold system

(75) Inventors: Ben-Haim Moshe, Haifa (IL); Ehrenfeld Ilan, Haifa (IL); Sagiv Shemi, Zichron Ya'akov (IL); Nowominski Armando, Haifa (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Sol Advanced Technologies Ltd.

(21) Appl. No.: 10/454,639

(22) Filed: Jun. 5, 2003

(51) Int. Cl. B29C 45/26; B29C 45/10

(52) U.S. Cl. 249/102; 425/542; 425/556; 425/470; 249/139; 249/155; 264/328.1

(57) ABSTRACT

Adjustable pin mold systems are provided, which include features specifically suited for injection molding of foamed polymers and for high-pressure injection molding of plastics.

### FIELD AND BACKGROUND OF THE INVENTION

The present invention relates generally to casting, or mold systems, and more particularly, to an adjustable pin mold system.

Adjustable casting systems are known. For example, U.S. Pat. No. 5,796,620, to Laskowski, et al., entitled, “Computerized system for lost foam casting process using rapid tooling set-up,” discloses a casting system, which utilizes conventional CAD/CAM software to automatically position the rods of a pin mold to replicate, by the rod end surfaces, the surface contours of an object drawn on a CAD machine when the object is cast in the pin mold. The system modifies the data base to account for the plastic liner and liner variations to permit production of Styrofoam cores in the Lost Foam Casting process while the pin mold incorporates a rod and hole configuration in the guide plates, which permits automatic positioning and frictional locking of the rods in the pin mold.

Additionally, U.S. Pat. No. 6,354,561, to Fahrion, entitled, “Adjustable casting mould, and device for adjusting the mould surface thereof,” discloses an adjustable casting mold system with two levels of adjustment. The first, or crude adjustment relates to adjusting pin assemblies, each comprising a plurality of pins. The crude adjustment may be considered digital in nature, since there are fixed positions for each assembly. The second, or fine adjustment, relates to adjusting the pins within each assembly. Each pin is threaded into the assembly, and its length may be adjusted with a screwdriver, to an exact position. U.S. Pat. No. 6,354,561, to Fahrion discloses a double mold, in which two surfaces may be adjusted, simultaneously, and various techniques for smoothing the surface of the molded product.

However, neither U.S. Pat. No. 5,796,620, to Laskowski nor U.S. Pat. No. 6,354,561, to Fahrion describes a pin mold system suitable for the specific needs of the plastic industry. There is thus a widely recognized need for, and it would be highly advantageous to have, an adjustable pin mold system devoid of the above limitations.

### SUMMARY OF THE INVENTION

According to one aspect of the present invention, there is provided a pin of an adjustable length, comprising:

an x;y;z coordinate system;

proximal and distal ends, with respect to an operator, defining +z and −z directions, respectively;

a screw, aligned with the z axis, and including:

a proximal portion, formed as a head, adapted to engage with a tool, for turning said screw, and adapted to engage with a locking mechanism, for preventing motion of said screw in the ±z direction, as said screw turns; and

a distal portion, formed as a stem, which issues from said head and which is threaded at least along part of its length; and

a pin body, aligned with the z axis, said pin body defining an inner cavity, having a threaded portion, adapted for threaded communication with said stem, wherein as said screw is turned in a first direction, into said pin body, the length of said pin along the z axis is shortened, and as said screw is turned in the reverse direction, the length of said pin is increased,

wherein said pin is adapted to withstand a pressure of at least 20 tons.

According to an additional aspect of the present invention, said pin is adapted to withstand a pressure of at least 100 tons.

According to an additional aspect of the present invention, said pin is adapted to withstand a pressure of at least 500.

According to an additional aspect of the present invention, said pin is adapted to withstand a pressure of at least 1000 tons.

According to an additional aspect of the present invention, said pin is adapted to withstand a pressure of at least 5000 tons.

According to an additional aspect of the present invention, said pin is adapted to withstand a pressure of at least 10000 tons.

According to an additional aspect of the present invention, said pin is adapted to withstand a pressure of at least 12000 tons.

According to an additional aspect of the present invention, said pin is adapted to withstand a pressure of at least 15000 tons.

According to an additional aspect of the present invention, said pin is adapted for temperatures of up to 400° C.

According to an additional aspect of the present invention, said pin further includes at least one through channel, operable for injection of a molding substance.

According to an additional aspect of the present invention, said pin further includes at least one through channel, operable for temperature control.

According to an additional aspect of the present invention, said pin further includes at least one through channel, operable for housing at least one sensor.

According to an additional aspect of the present invention, said inner cavity of said pin is a lumen, which runs the length of said pin body.

According to an additional aspect of the present invention, said pin assembly is adapted for the production of insole molds.

According to an alternative aspect of the present invention, said pin assembly is adapted for the production of packaging materials.

According to an additional aspect of the present invention, there is provided a pin assembly, comprising:

an x;y;z coordinate system;

proximal and distal ends, with respect to an operator, defining +z and −z directions, respectively;

an array of pins of adjustable lengths, having m by n pins, wherein both m and n are integers, each individually selected from the group consisting of 1, 2, and integers greater than 2, and wherein each pin comprises:

a screw, aligned with the z axis, and including:

a proximal portion, formed as a head, adapted to engage with a tool, for turning said screw, and adapted to engage with a locking mechanism, for preventing motion of said screw in the ±z direction, as said screw turns; and

a distal portion, formed as a stem, which issues from said head and which is threaded at least along part of its length; and

a pin body, aligned with the z axis, said pin body defining an inner cavity, having a threaded portion, adapted for threaded communication with said stem, wherein as said screw is turned in a first direction, into said pin body, the length of said pin along the z axis is shortened, and as said screw is turned in the reverse direction, the length of said pin is increased; and

said locking mechanism, adapted for engagement with said screw heads, for preventing motion of said screws in the ±z direction, as said screws turn,

wherein said pin assembly is adapted to withstand a pressure of at least 20 tons.

According to an additional aspect of the present invention, said locking mechanism includes:

a first plate, on the proximal side of, and abut against said screw heads, for preventing any of said screws from moving proximally;

a second plate, on the distal side of and abut against said screw heads, for preventing any of said screws from moving distally; and

bolts for holding said first and second plates together.

According to an alternative aspect of the present invention, said locking mechanism includes:

a first plate, on the proximal side of, and abut against said screw heads, for preventing any of said screws from moving proximally; and

locking ohms, arranged on said screws, on the distal side of and abut against said screw heads, for preventing said screws from moving distally.

According to an additional aspect of the present invention, said array further includes sidewalls, which are bolted to each other, in a direction selected from the group consisting of clockwise and counterclockwise directions, for pressing said pins tightly to each other.

According to an additional aspect of the present invention, said array of pins may be selectively disassembled and rearranged into a different array.

According to another aspect of the present invention, there is provided an injection molding press, comprising:

a first, stationary pin assembly, which includes:

an x;y;z coordinate system;

proximal and distal directions, defined as +z and −z directions, respectively;

a first array of pins of adjustable lengths, having m1 by n1 pins, wherein both m1 and n1 are integers, each individually selected from the group consisting of 1, 2, and integers greater than 2, and wherein each pin comprises:

a screw, aligned with the z axis, and including:

a proximal portion, formed as a head, adapted to engage with a tool, for turning said screw, and adapted to engage with a locking mechanism, for preventing motion of said screw in the ±z direction, as said screw turns; and

a distal portion, formed as a stem, which issues from said head and which is threaded at least along part of its length; and

a pin body, aligned with the z axis and having a distal-most surface, said pin body defining an inner cavity, having a threaded portion, adapted for threaded communication with said stem, wherein as said screw is turned in a first direction, into said pin body, a length of said pin along the z axis is shortened, and as said screw is turned in the reverse direction, the length of said pin is increased;

said locking mechanism, adapted for engagement with said screw heads, for preventing motion of said screws in the ±z direction, as said screws turn;

a first tool, mounted on a first gantry on the proximal side of said first pin assembly, for adjusting the lengths of said pins of said first pin assembly, so as to form a distal-most cavity, therein; and

a first portion of mold insert, embedded within said first pin assembly, within said distal-most cavity, said first portion of mold insert defining a first inner space, for forming a first portion of a mold;

an injection system, external to said first pin assembly and in liquid communication with said first portion of mold insert, through at least one channel, arranged along at least one pin; and

a pressure applicator, capable of producing a pressure of at least 20 tons, said pressure applicator comprising:

a press gantry, which provides movement in the ±z direction;

a second pin assembly, comprising a second array of m2 by n2 of said pins, wherein both m2 and n2 are integers, each individually selected from the group consisting of 1, 2, and integers greater than 2, and wherein said second array is constructed in a manner analogous to said first array, but arranged as mirror image across the x;y plane, to said first array, on said press gantry;

a second tool, mounted on a second gantry on the distal side of said second pin assembly, for adjusting the lengths of said pins of said second pin assembly, so as to form a proximal-most cavity, therein; and

a second portion of mold insert, embedded within said second pin assembly, within said proximal-most cavity, said second portion of mold insert defining a second inner space, for forming a second portion of said mold,

wherein as said pressure applicator brings said first and second pin assemblies abut, said first and second portions of mold insert come together and form a complete mold insert and said first and second inner spaces form said mold, under said pressure.

According to an additional aspect of the present invention, said second pin assembly further includes at least one mold ejector, arranged in at least one channel within said pins, for providing travel into said second inner space, for ejecting said mold.

According to an additional aspect of the present invention, said second pin assembly further includes at least two mold ejectors, arranged in channels within said pins, for providing travel into said second inner space, for ejecting said mold.

According to an additional aspect of the present invention, said injection system includes at least two channels, arranged in said first pin assembly, for providing liquid communication with said first portion of mold insert.

According to an additional aspect of the present invention, said first pin assembly further includes sidewalls, which are bolted to each other, in a direction selected from the group consisting of clockwise and counterclockwise directions, for pressing said pins tightly to each other.

According to an additional aspect of the present invention, said second pin assembly further includes sidewalls, which are bolted to each other, in a direction selected from the group consisting of clockwise and counterclockwise directions, for pressing said pins tightly to each other.

According to another aspect of the present invention, there is provided method of plastic injection molding comprising:

providing an injection molding press, comprising:

a first, stationary pin assembly, which includes:

an x;y;z coordinate system;

proximal and distal directions, defined as +z and −z directions, respectively;

a first array of pins of adjustable lengths, having m1 by n1 pins, wherein both m1 and n1 are integers, each individually selected from the group consisting of 1, 2, and integers greater than 2;

a first tool, mounted on a first gantry on the proximal side of said first pin assembly, for adjusting the lengths of said pins of said first pin assembly, so as to form a distal-most cavity, therein; and

an injection system, external to said first pin assembly and in liquid communication with said distal-most cavity, through at least one channel, arranged along at least one pin; and

a pressure applicator, capable of producing a pressure of at least 20 tons, said pressure applicator comprising:

a press gantry, which provides movement in the ±z direction;

a second pin assembly, comprising a second array of m2 by n2 of said pins, wherein both m2 and n2 are integers, each individually selected from the group consisting of 1, 2, and integers greater than 2, and wherein said second array is constructed in a manner analogous to said first array, but arranged as mirror image across the x;y plane, to said first array, on said press gantry; and

a second tool, mounted on a second gantry on the distal side of said second pin assembly, for adjusting the lengths of said pins of said second pin assembly, so as to form a proximal-most cavity, therein;

arranging pins of at least one of said first and second pin arrays, to form at least one cavity;

bringing said first and second pin assemblies together, by said pressure applicator, thus forming an inner space therein, and applying pressure thereto;

injecting the plastic fluid to said inner space, under said pressure;

separating said first and second pin assemblies, by said pressure applicator; and

ejecting a plastic mold product, formed within said inner space.

According to an additional aspect of the present invention, said method includes placing first and second insert portions, in said distal-most and proximal-most inner spaces.

The present invention successfully addresses the shortcomings of the presently known configurations by providing adjustable pin mold systems, which include features specifically suited for injection molding of foamed polymers and for high-pressure injection molding of plastics.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1E schematically illustrate a pin assembly, in accordance with a preferred embodiment of the present invention;

FIGS. 2A-2I schematically illustrate a pin in accordance with other preferred embodiments of the present invention;

FIGS. 3A-3B schematically illustrate pin assemblies in accordance with other preferred embodiments of the present invention;

FIGS. 4A-4C schematically illustrate a mold box, in accordance with a preferred embodiment of the present invention;

FIGS. 5A-5C schematically illustrate a gantry for turning the screws, in accordance with a preferred embodiment of the present invention;

FIGS. 6A-6D schematically illustrate examples of molds, in accordance with preferred embodiments of the present invention;

FIGS. 7A and 7B schematically illustrate mold boxes, in accordance with other preferred embodiments of the present invention;

FIGS. 8A-8D schematically illustrate pins, screws, and pin assemblies, adapted for high-load applications, in accordance with preferred embodiments of the present invention;

FIGS. 9A-9E schematically through channels for mold injection, for temperature control, such as cooling or heating, and for wiring and housing of various sensors, in accordance with a preferred embodiment of the present invention;

FIGS. 10A-10D schematically illustrate a first stage in the injection molding of plastics, in accordance with a preferred embodiment of the present invention;

FIG. 11 schematically illustrates an injection-molding press for injection molding of plastics, in accordance with a preferred embodiment of the present invention;

FIGS. 12A-12D, together, schematically illustrate the process of injection molding in accordance with a preferred embodiment of the present invention;

FIG. 13 is a schematic, pictorial representation of injection molding press, in accordance with a preferred embodiment of the present invention;

FIGS. 14A-14B schematically illustrate a first product 100 which may be molded by first and second insert portions 102 and 104, and injection-molding press 130 of the present invention;

FIGS. 15A-15B schematically illustrate a second product 100 which may be molded by first and second insert portions 102 and 104, and injection-molding press 130 of the present invention;

FIGS. 16A-16B schematically illustrate a third product 100 which may be molded by first and second insert portions 102 and 104, and injection-molding press 130 of the present invention; and

FIG. 17 schematically illustrates a plastic mold product, formed directly, without mold inserts.

### DESCRIPTION OF THE PREFERRED EMBODIMENTS

The present invention is of adjustable pin mold systems, which include features specifically suited for injection molding of foamed polymers and for high-pressure injection molding of plastics.

The principles and operation of the device and method according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

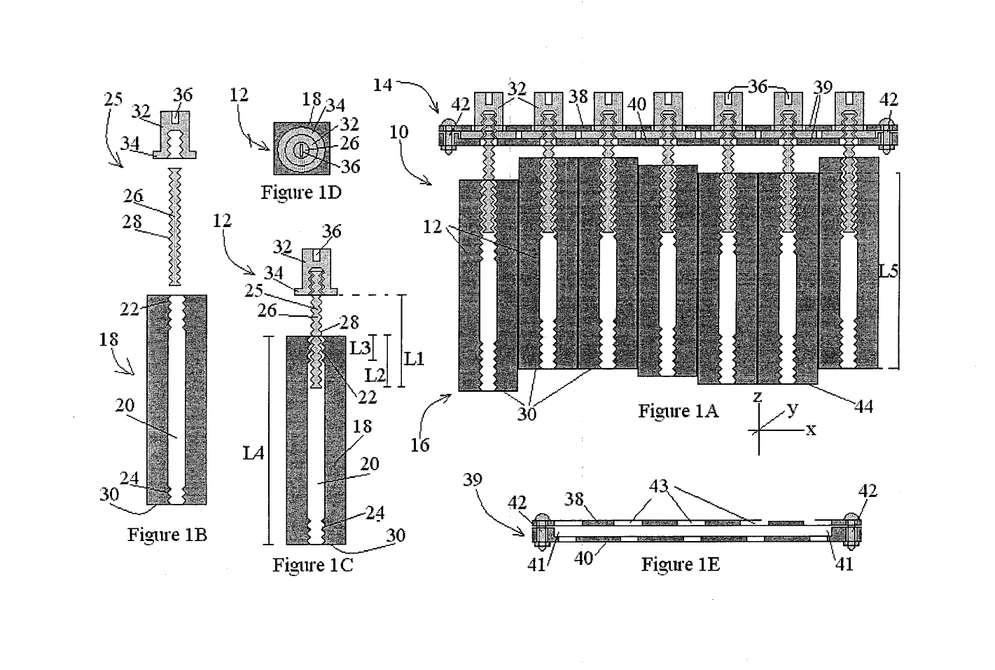

Referring now to the drawings, FIGS. 1A-1E schematically illustrate a pin assembly 10, comprising a plurality of pins 12, in accordance with a preferred embodiment of the present invention. Pin assembly 10 (FIG. 1A) defines a proximal end 14, and a distal end 16, with respect to an operator (not shown). Additionally, pin assembly 10 defines an x;y;z coordinate system, such that the z-axis runs along the longitudinal axis of the pins, and +z is the proximal direction.

Each pin 12 (FIGS. 1B and 1C) includes a pin body 18, which preferably has a cubical cross section (FIG. 1D), although other cross sections, for example, rectangular or hexagonal, may also be used. The cross sectional dimensions of pin body 18 may be for example, 6 mm ×6 mm and its length may be between 5 cm and 60 cm. Pin body 18 may be formed of a metal or a metal alloy, for example, stainless steel, steel, aluminum, or Zircalloy. Alternatively, pin body 18 may be formed of graphite, or another suitable material, as known. Preferably pin body 18 has a low coefficient of thermal expansion and a low coefficient of friction. Alternatively or additionally, a coating of a low coefficient of friction may be applied to pin body 18.

It will be appreciated that other materials, cross-sectional shapes, and dimensions may similarly be used.

Pin body 18 defines an inner cavity 20, preferably formed as a through lumen 20 (FIGS. 1B and 1C), preferably, of a circular cross section. A proximal portion 22 of inner cavity 20 is threaded. Additionally, lumen 20 may include a distal threaded portion 24. Alternatively, distal portion 24 is not threaded.

Pin 12 further includes a screw 25, which includes a stem 26, with a threaded portion 28, for threading into proximal threaded portion 22 of pin body 18. At its distal end, pin 12 defines a distal surface 30.

Moreover, pin 12 includes a screw head 32, operable to thread over screw stem 26. Alternatively, head 32 and stem 26 may be formed as a solid unit.

Head 32 is adapted to engage with a tool (not shown) for turning screw 25. The tool may be, for example, a screwdriver, a Phillips screwdriver, an Ellan key, a wrench, or the like. For example, head 32 may include a slot 36 at its proximal-most surface, for engaging with a screwdriver.

Additionally, head 32 is adapted to engage with a locking mechanism, described hereinbelow, in conjunction with FIGS. 1A and 1E. For example, head 32 may include a rim 34 for engaging with the locking mechanism.

Screws 25 may be formed, for example of stainless steel or aluminum and be between 3 cm and 30 cm in length and between 3 mm and 25 mm in diameter. It will be appreciated that other materials and dimensions may similarly be used.

As seen in FIGS. 1A and 1E, pin assembly 10 further includes a locking mechanism 39, for preventing motion of screw 25 along the ±z direction, as screw 25 turns. Locking mechanism 39 may comprise first and second plates 38 and 40, which are fastened to each other, for example with bolts 42. Plates 38 and 40 form a depression 41 (FIG. 1E), within which rims 34 of screws 25 sit.

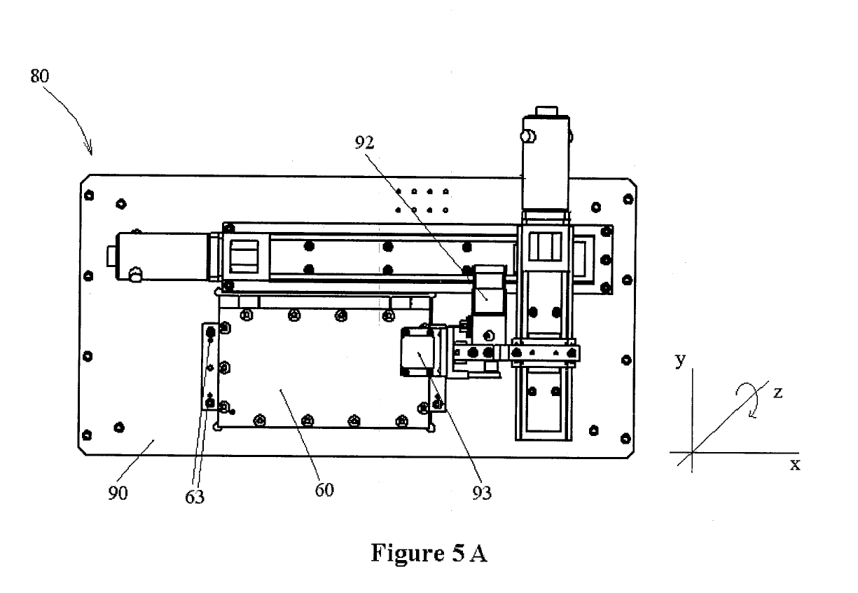

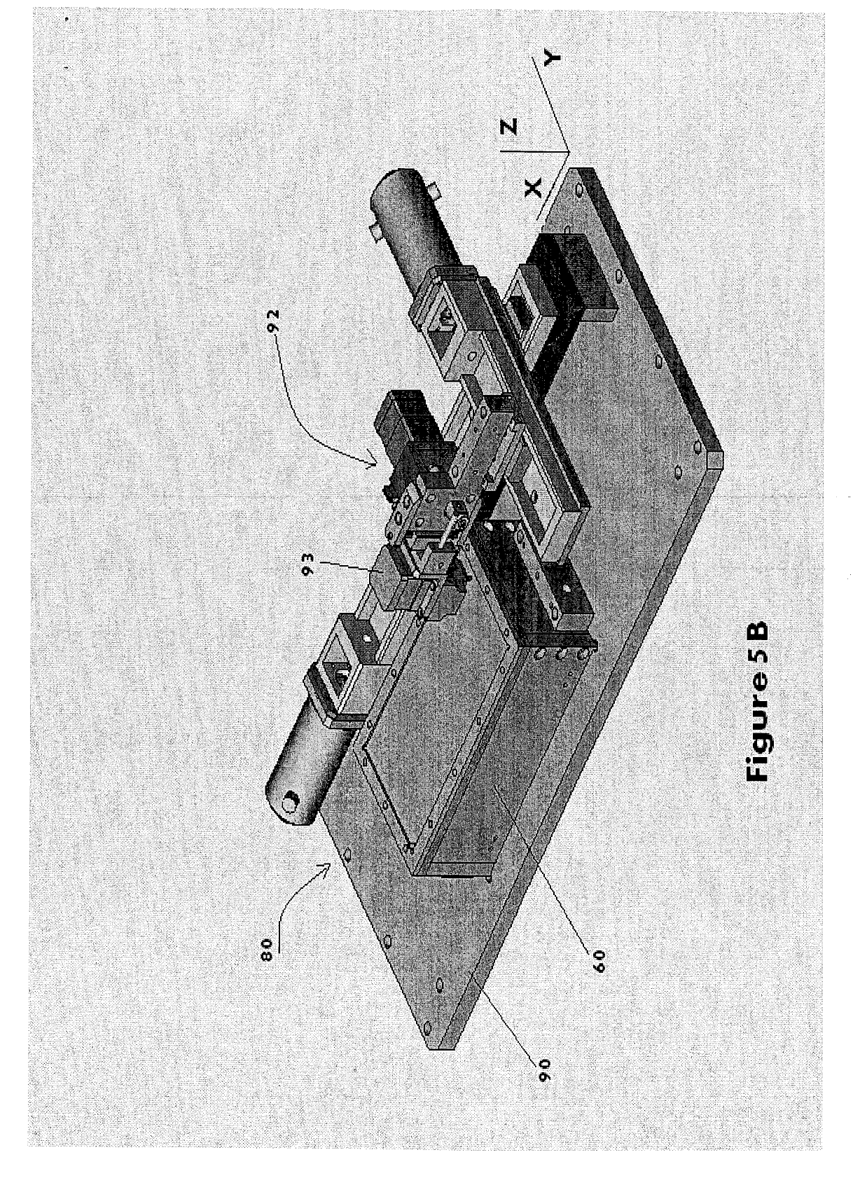

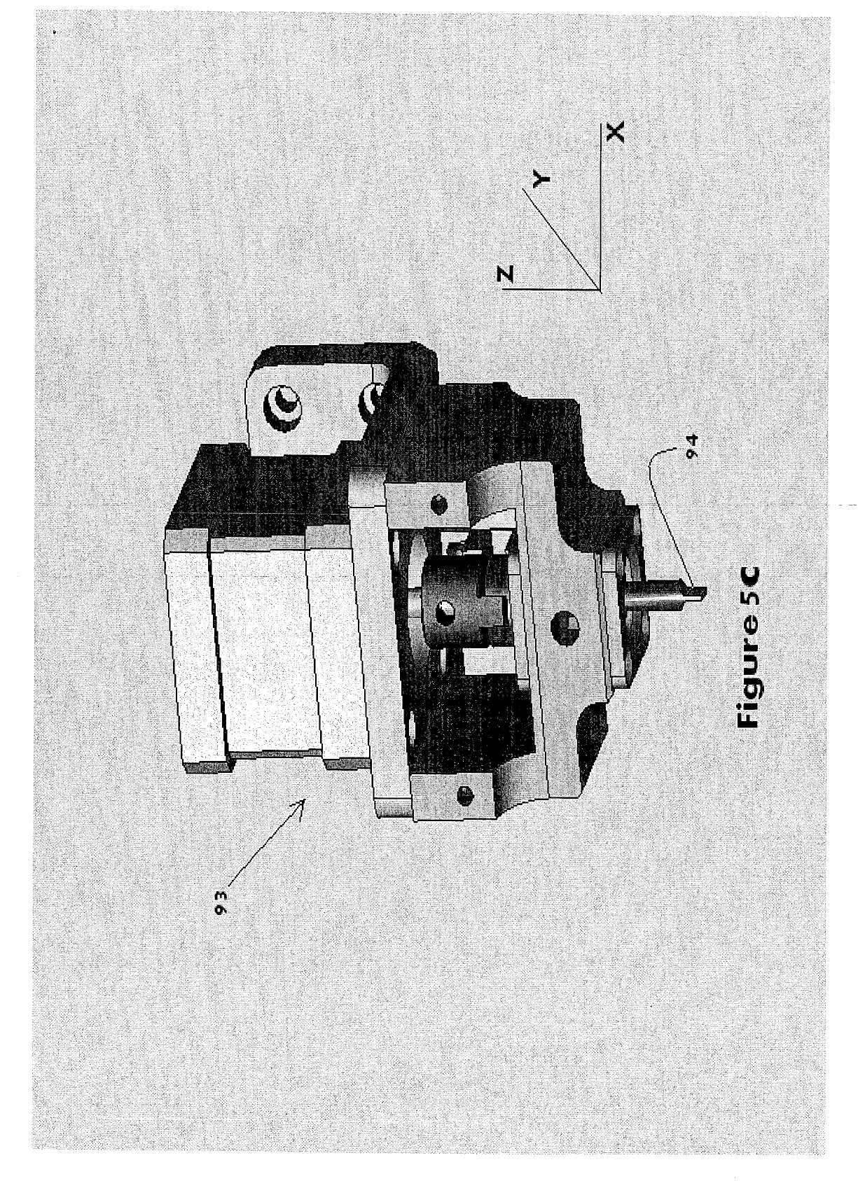

It will be appreciated that first plate 38 may have through holes 43 (FIG. 1E), through which screw heads 32 protrude, for engagement with a tool platform 92, as described hereinbelow in conjunction with FIG. 5, for turning screws 25. Alternatively, first plate may be solid, and mounted only after screws 25 are properly positioned by tool platform 92.

When pins 12 are arranged in pin assembly 10, their distal surfaces 30 define a mold surface 44, which generally has a staircase-like appearance.

Defining a length L1 (FIG. 1C), as the overall length of screw 25, a length L2, as the length of screw 25 within pin body 18, a length L3, as the length of proximal threaded portion 22, a length L4, as the overall length of pin 18, and L5 (FIG. 1A), as the extent of overlap between two adjacent pins, it will be noted that:

i. Preferably, L2, the length of screw 25 within pin body 18 is at least about 20% of length L1, the overall length of screw 25;

ii. Preferably, L2, the length of screw 25 within pin body 18 is also at least about 20% of length L4, the overall length of pin body 18;

iii. While L3, the length of proximal threaded portion 22, may be smaller than, equal to, or larger than L2, the length of screw 25 within pin body 18, it is preferably smaller than L2, to minimize friction;

iv. some overlap between adjacent pins must occur, and preferably, L5, the extent of overlap between two adjacent pins is at least 40% of L4, the overall length of pin body 18;

It will be appreciated that other relations between the lengths parameters are also possible.

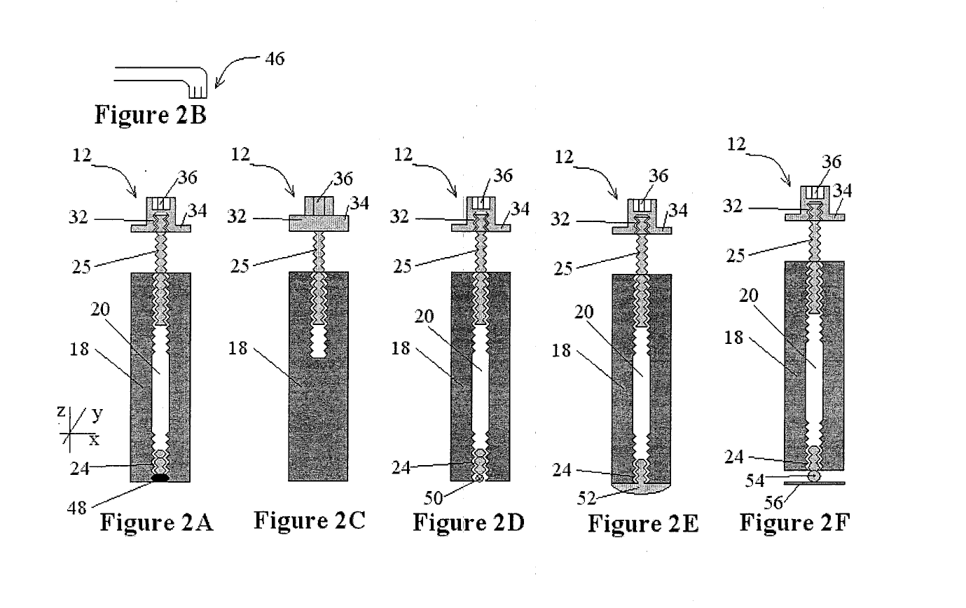

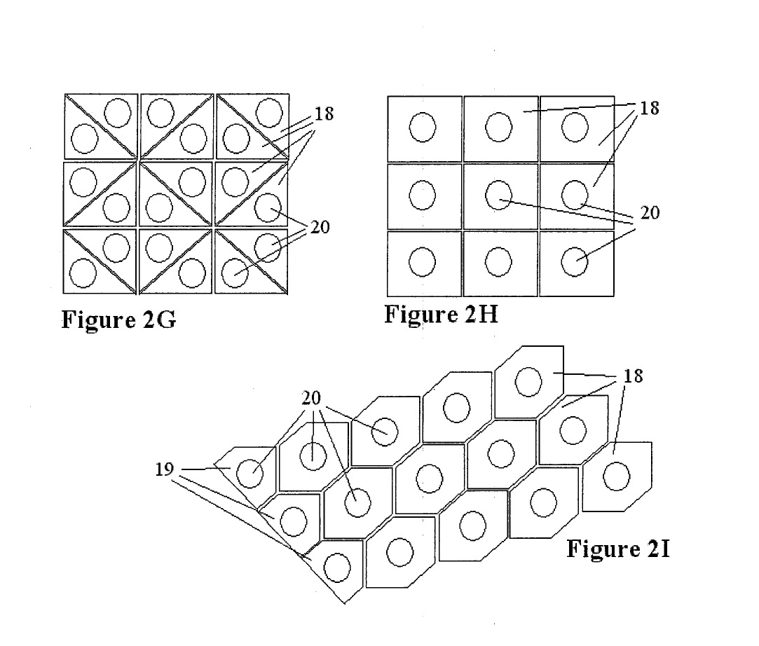

Referring further to the drawings, FIGS. 2A-2I schematically illustrate pin 12 in accordance with other preferred embodiments of the present invention.

As seen in FIGS. 2A and 2B, screw 25 may have an Ellen cavity 36, for engaging with an Ellen key 46. Preferably, Ellen cavity 36 is hexagonal. The advantage of having a hexagonal cavity is the greater flexibility in the orientation of key 46, for insertion into Ellen cavity 36, when compared to a conventional screwdriver slot. This flexibility is important when the rotation of screw 25 is performed by a robot, or by a computer.

Additionally, as seen in FIG. 2A, an endplug 48 may be inserted into threaded distal portion 24.

As seen in FIG. 2C, screw 25 is formed as a solid unit, with head 32 including a hexagonal proximal portion 36, for engaging with a wrench (not shown). Additionally, as seen in FIG. 2C, inner cavity 20 extends only partly through pin body 18.

As seen in FIG. 2D, a sensor 50 may be inserted into threaded distal portion 24.

As seen in FIG. 2E, a concave distal surface 52 may be inserted into threaded distal portion 24. Alternatively, another shape may be used.

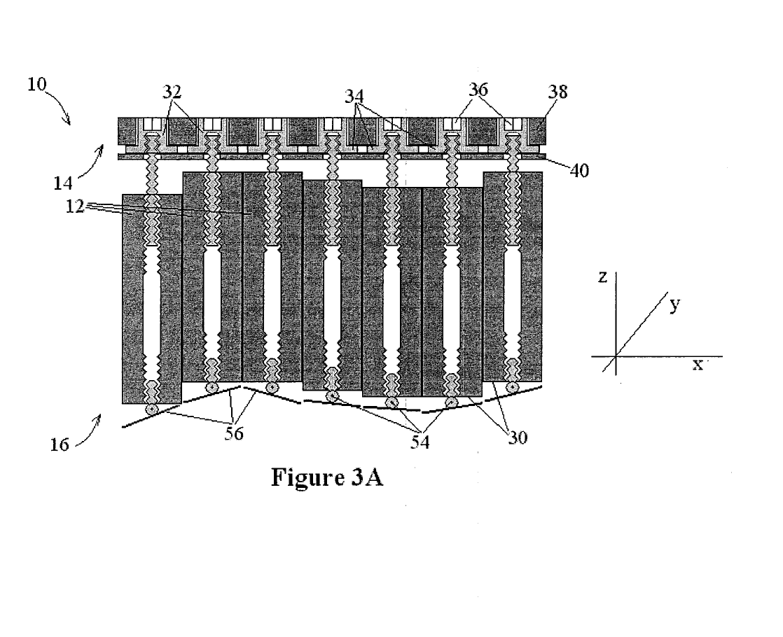

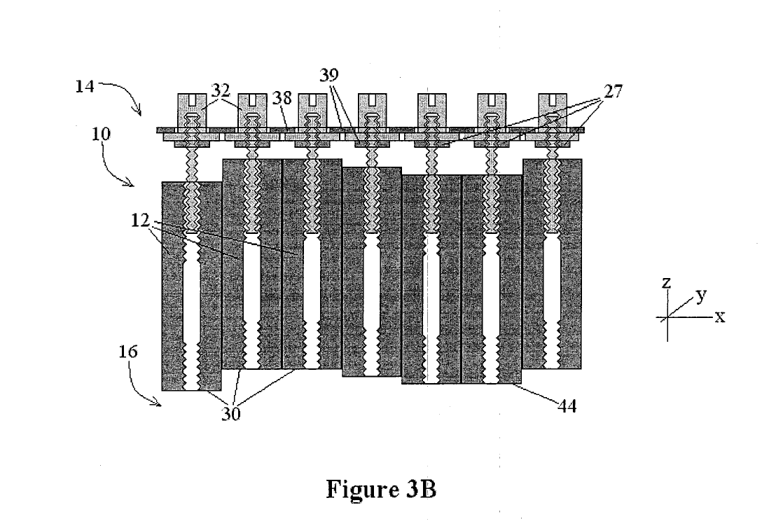

As seen in FIG. 2F, a ball and socket hinge 54 and a plate 56 may be inserted into threaded distal portion 24. The operation of ball and socket hinge 54 and plate 56, in smoothing generally staircase-like appearance of mold surface 44 (FIG. 1A) is described hereinbelow, in conjunction with FIG. 3A.

FIGS. 2G, 2H and 21 schematically illustrate other cross sections of pin bodies 18, such as triangular (FIG. 2G), square (FIG. 2H) and hexagonal (FIG. 2I), which further includes an edge pin 19, for forming a straight edge. It will be appreciated that other cross sections are also possible.

Referring further to the drawings, FIGS. 3A-3B schematically illustrate pin assembly 10 in accordance with other preferred embodiments of the present invention.

FIG. 3A schematically illustrates assembly 10, which further includes hinges 54 and plates 56, at distal end 16, for smoothing out the mold surface. Plates 56, mounted on hinges 54 may be oriented by the pressure of the injected mold liquid, so as to smooth out somewhat the staircase-like appearance of the mold surface. It will be appreciated that the smoothing out, in accordance with the present embodiment, may take place either in the x direction or in the y direction, or at some angle to the x and y directions.

FIG. 3B schematically illustrates assembly 10 wherein locking mechanism 39 comprises first plate 38, on the proximal sides of, and abut against rims 34, and locking ohms 27, on the distal sides of heads 32.

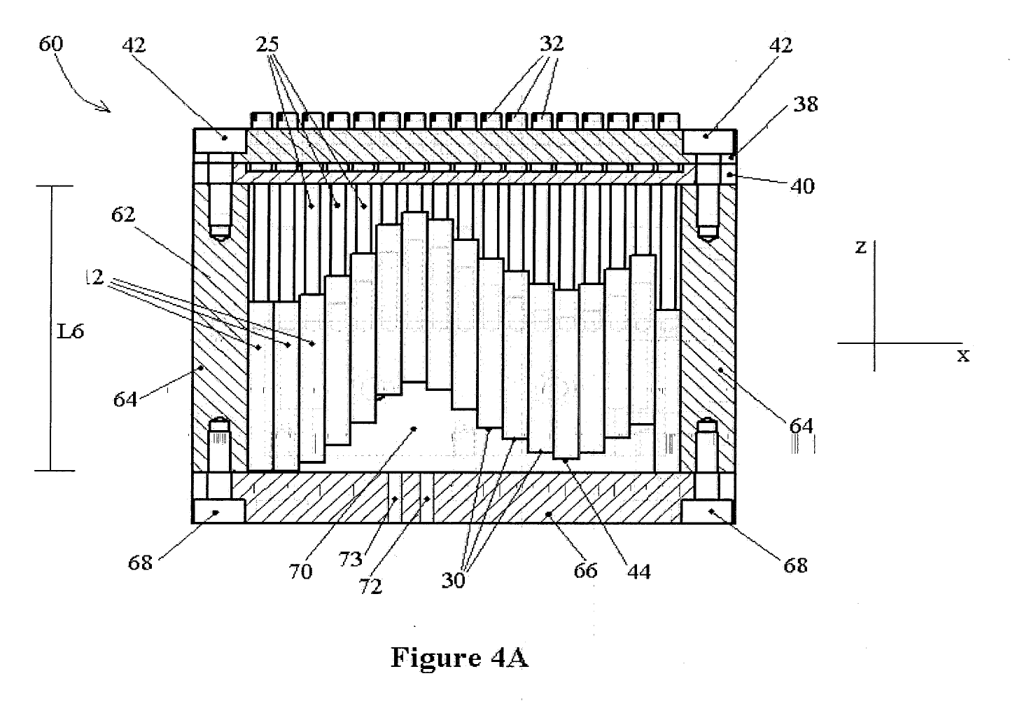

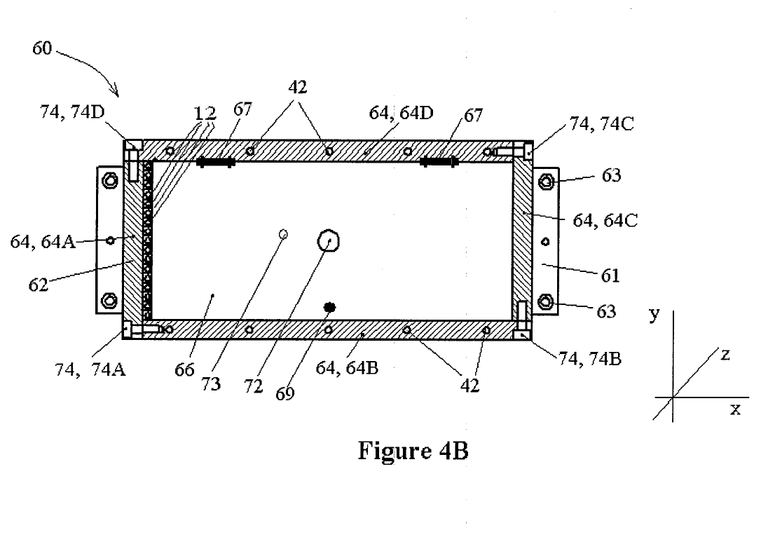

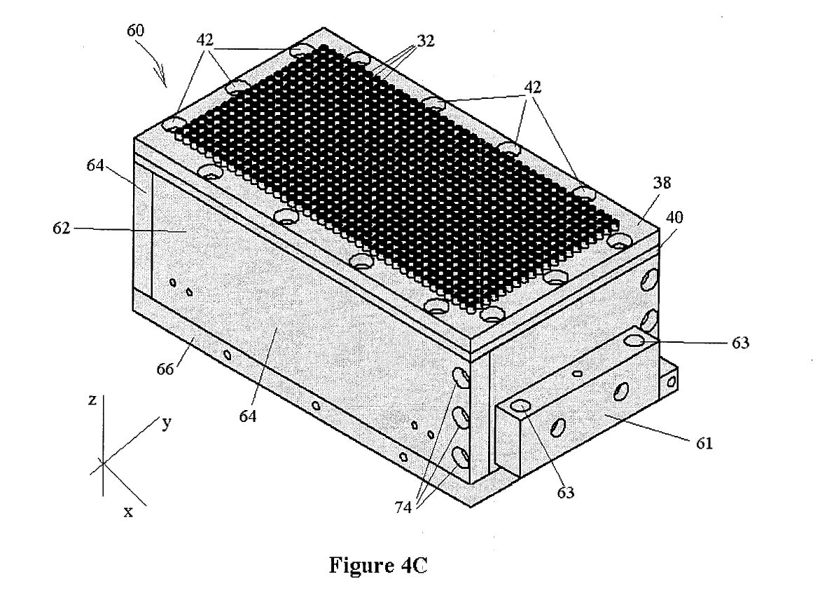

Referring further to the drawings, FIGS. 4A-4C schematically illustrate a mold box 60, in accordance with a preferred embodiment of the present invention.

FIG. 4A schematically illustrates a view in the x:z plane of mold box 60, showing pins 12, arranged at different positions along the z axis, in a frame 62, so as to define a mold cavity 70, between mold surface 44 and frame 62. Frame 62 includes first and second plates 38 and 40, sidewalls 64 and a distal plate 66. Preferably, bolts 42, which hold first and second plates 38 and 40 together, further fix these plates to sidewalls 64. Preferably, bolts 68 fix distal plate 66 to sidewalls 64.

It will be appreciated that first plate 38 may be inserted after screws 25 are turned for setting pins 12 to their proper heights.

Screw heads 32 are exposed through first and second plates 38 and 40, to enable the adjustment of the axial positions of pins 12 in the z-axis.

An injection hole 72 may be provided, for example, in distal plate 66. Additionally, an air vent 73 may be provided, for allowing air to escape, during injection. Alternatively, a vacuum may be produced prior to injection.

Alternatively, second plate 40 is not used, and locking ohms 27 (FIG. 3B) are used instead. Bolts 42 may then be used to fasten plate 38 to sidewalls 64.

FIG. 4B schematically illustrates a view in the x;y plane of mold box 60 and distal plate 66, illustrating sidewalls 64, which include sidewalls 64A, 64B, 64C and 64D. For simplicity, only one line of pins 12 are shown.

As has been pointed out, hereinabove, in conjunction with FIGS. 1A and 1C, preferably, L5, the extent of overlap between two adjacent pins is at least 40% of L4, the overall length of pin body 18. In consequence, a length L6 of sidewalls 64A, 64B, 64C and 64D (FIG. 4B), is preferably about 160% of L4, the overall length of pin body 18. It will be appreciated that other relations between the lengths parameters are also possible.

Preferably, bolts 74, comprising bolts 74A-74D are used to fasten sidewalls 64 together, preferably in a counterclockwise direction or a clockwise direction, as follows:

Sidewalls 64A and 64B are fastened to each other with bolt 74A, and side walls 64C and 64D are fastened to each other with bolt 74C, running in an opposite direction to bolt 74A, thus forming two L shapes.

The two L shapes are then fastened to each other with bolts 74B and 74D, running in opposite directions to each other, so as to form either a clockwise direction, or a counterclockwise direction with bolts 74A and 74C.

The advantage of maintaining a clockwise or a counterclockwise direction for bolts 74A-74D is the improved tightening of sidewalls 64, which in turn tightens pins 12, pressing them against each other.

Preferably, bottom plate 66 is positioned on hinges 67 and includes a knob 69, so as to open, like a door, for removing the mold product.

A side plate 61 is used for fixing mold box 60 onto a working platform (not shown), for example, via screw holes 63.

Additionally, carrying handles (not shown) may be attached mold box 60, for example, to side plate 61.

FIG. 4C is a pictorial view of mold box 60, showing screw heads 32 and frame 62, comprising first and second plates 38 and 40, sidewalls 64, and bolts 42 and 74. As seen, there are pluralities of bolts 42 and 74 along frame 62.

In accordance with the present invention, frame 62 is preferably formed of stainless steel or aluminum. The external dimensions of mold box 60 may be, for example, 30 cm in length and 20 cm in width. The thickness of plate 38 may be, for example, between 10 mm and 15 mm. The thickness of plate 40 may be, for example, between 5 mm and 10 mm. The thickness of sides 64 may be, for example, between 10 mm and 25 mm. The thickness of bottom plate 66 may be, for example, between 10 mm and 25 mm. It will be appreciated that other dimensions and materials are similarly possible.

Bolts 42 may be, for example between M5 and M10, and bolts 74 may similarly be, for example, between M5 and M10. Both are preferably formed of stainless steel or steel. It will be appreciated that other dimensions and materials are similarly possible.

Mold box 60 may include, for example, between 800 and 15,000 pins 12, arranged, for example, in an array of 20 ×40, or an array of 100 ×150, or any other array. It will be appreciated that other values are possible. Additionally, pins 12 may be formed to a standard size but arranged in mold boxes 60 of different sizes. That is, the same pins 12 may be arranged in mold boxes 60 of different sizes. Furthermore, pins 12 may be removed from one mold box 60 and re-assembled into a different mold box 60, for example, of a different size.

In accordance with the present invention, mold box 60 is generally designed to withstand mold pressures of up to 50 atmospheres and mold temperatures of up to 100° C. These conditions are most suitable for injection molding of polymeric foams, for example, polyurethane, Styrofoam, and the like, and of silicon polymers such as neutral RTV silicon, and the like. These may be used, for example, as packaging materials.

Referring further to the drawings, FIGS. 5A-5C schematically illustrate a gantry system 80 for turning screws 25 (FIGS. 1B and 4A), in accordance with a preferred embodiment of the present invention. Gantry system 80 includes a gantry 92, arranged on a base 90, parallel to the x;y plane, and includes a tool support 93, having a tool 94 (FIG. 5C), for turning screws 25. Mold box 60 is similarly arranged on base 90, preferably fixed onto it with screws 63.

Tool 94 may be screw-driver like, Phillips-screw-driver like, Ellen-key like, wrench-like, or formed as another tool, operative to engage with heads 32 and rotate screws 25. Preferably, gantry 92 is adapted for motion along the x-axis, the y-axis, the z-axis, and rotation along the axis perpendicular to base 90. Preferably, gantry 80 is operated by a computer (not shown) or by a robot (not shown). It will be appreciated that screws 25 may also be rotated manually, with a hand-held tool. It will be appreciated that two or more tools 94 may operate together. For example, each tool 94 may be arranged on a gantry that covers one half, or one fourth of base 90, with each gantry working independently. It will be appreciated that other arrangements are also possible.

In accordance with an embodiment of the present invention, gantry system 80 may be arranged on the injection system for mold box 60.

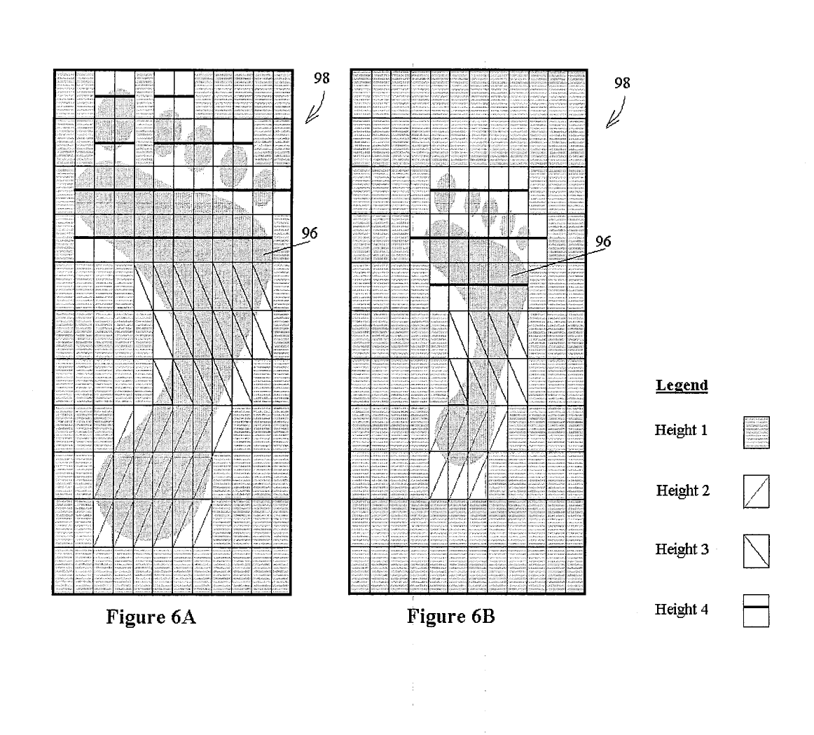

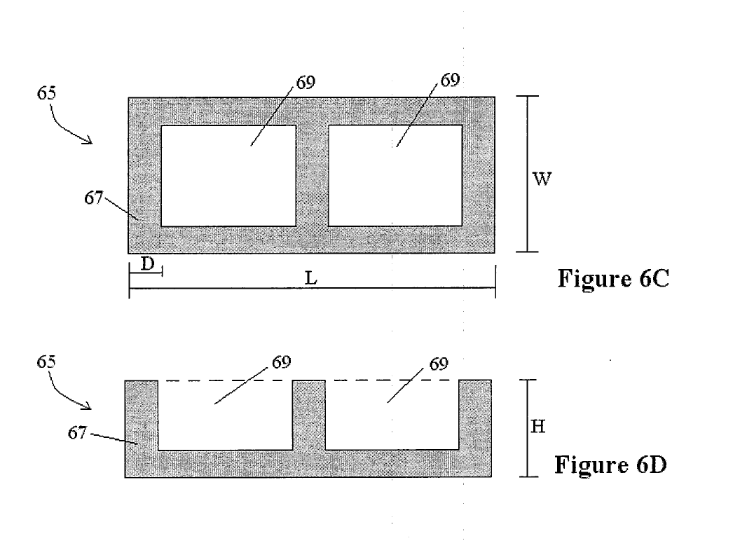

Referring further to the drawings, FIGS. 6A-6D schematically illustrate examples of mold products, produced by mold box 60, in accordance with embodiments of the present invention.

FIGS. 6A and 6B schematically illustrate foot imprints 96 and insole molds 98, as produced by mold box 60. In the present examples, insole molds 98 have three height levels, above zero height (height 1). It will be appreciated that a larger or smaller number of height levels may be used. It will be appreciated that the insole molds are cut generally along foot imprints 96.

FIGS. 6C and 6D schematically illustrate a packaging box 65, of Styrofoam. Packaging box 65 has a length L of about 18 cm, a width W of 7 cm, a height H of 6 cm, and a wall thickness D of 1.5 cm. It will be appreciated that these values are exemplary; other shapes, materials and dimensions may be used.

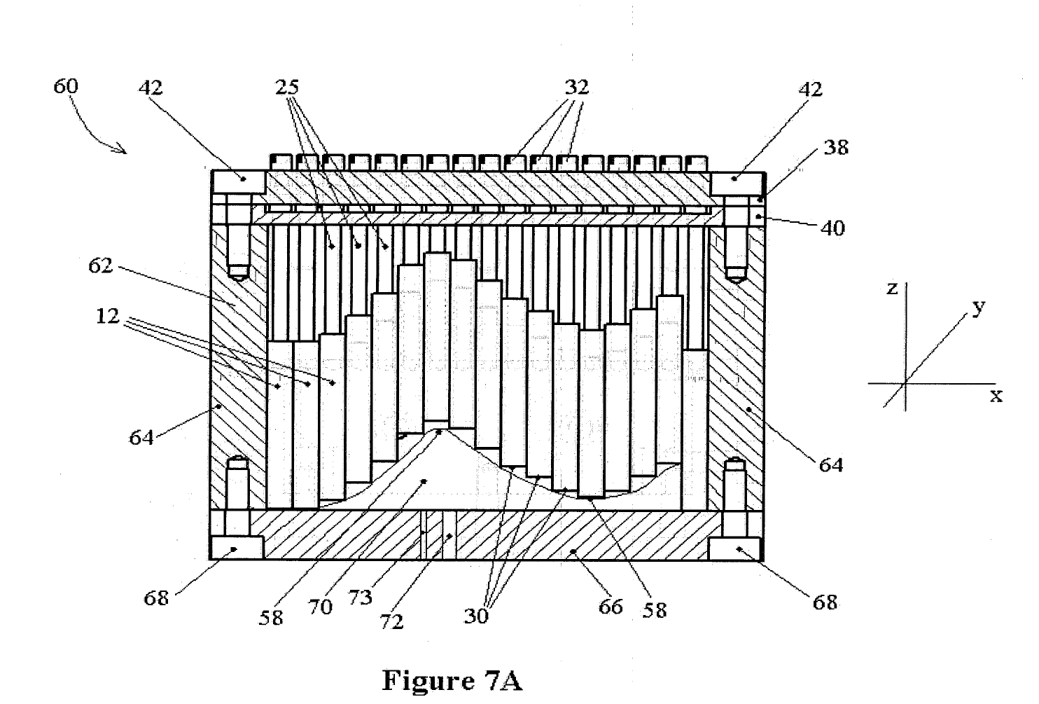

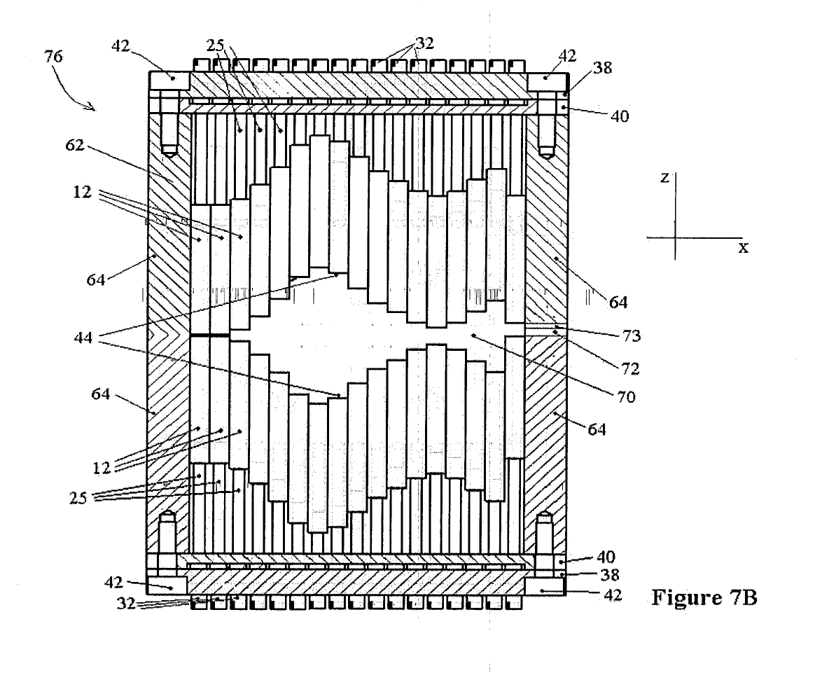

Referring further to the drawings, FIGS. 7A and 7B schematically illustrate mold boxes, in accordance with other preferred embodiments of the present invention.

FIG. 7A illustrates mold box 60, which further includes a sheet 58 for smoothing out the staircase-like surface of the mold. Sheet 58 may be a fabric, such as cotton, polyester, and the like, and may adhere to the mold product, and smooth out its final surface. Alternatively, sheet 58 may be a flexible material, such as nylon, polyethylene, natural rubber, chemically modified natural rubber, a synthetic polymer, a metal foil, Mylar, PVC, a metalized polymer, a laminated sheet of metal and polymer, or another known flexible material.

For example, if the mold product is a insole, such as shown in FIGS. 6A and 6B, sheet 58 of cotton may be used both for smoothing out the mold external surface and for forming a cotton interface with the foot.

FIG. 7B illustrates an x;z view of a double mold box 76. In accordance with the present embodiment, injection hole 72 and vent 73 may be provided in one of sidewalls 64. It will be appreciated that the length adjustment of the two pin assemblies in double mold box 76 need not be symmetric.

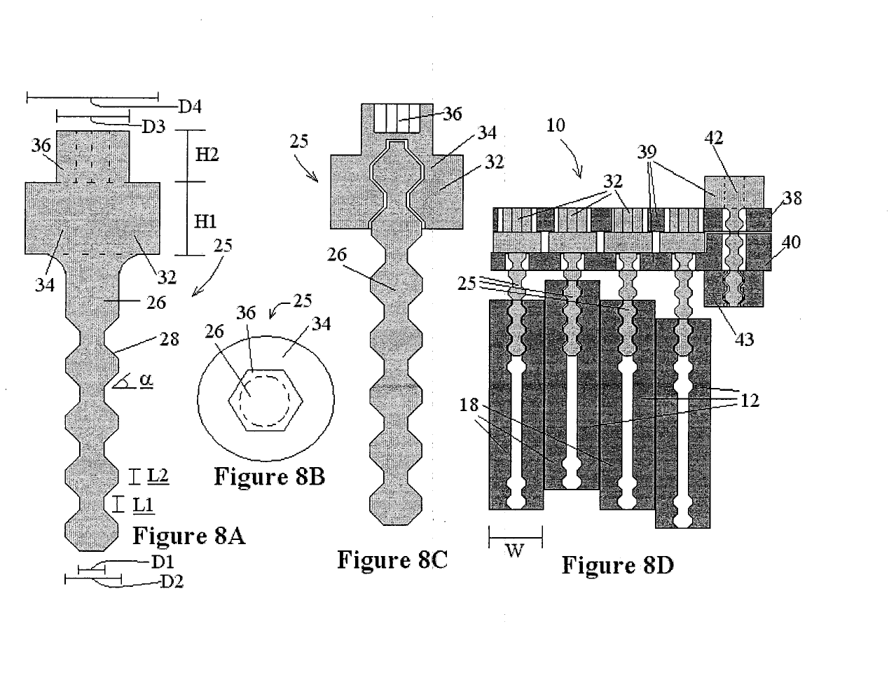

Referring further to the drawings, FIGS. 8A-8D schematically illustrate pins 12, screws 25 and pin assemblies 10, adapted for high-load applications in the injection molding of plastics, in accordance with preferred embodiments of the present invention. The injection molding of plastics involves a pressure of between 20 tons and 15,000 tons, and temperatures of up to 400° C.

FIGS. 8A and 8B illustrate high-load screw 25, formed as a solid unit, and having hexagonal proximal portion 36, adapted to engage with a wrench. Screw 25 of the present embodiment may be formed, for example of stainless steel or steel, preferably, as a trapezic-profile screw of between M4 and M25.

Alternatively, screws 25 of the present embodiment may be special screws for plastic mold, formed for examle, of alloy steel, as socket-headed-cap screws, having a profile of between M4 and M20, and adapted to withstand pressures of up to 125 kg/mm². These screws may be obtained, for example, from D-M-E Co., of Madison Heights Mich. USA. Alternatively, special screws for plastic molds may be obtained from Husco Engineering Co, of Wilton, Conn., USA.

It will be appreciated that other materials and dimensions may similarly be used.

Alternatively, FIG. 8C schematically illustrate high-load screw 25, formed as a stem 26, which is threaded into head 32. Head 32 may include Ellen cavity 36, for engaging with an Ellen key 46 (FIG. 2B). It will be appreciated that other configurations, for example, as illustrated in the embodiments of FIGS. 1A-3B may similarly be used.

FIG. 8D illustrates pin assembly 10 adapted for high-load applications. Plates 38 and 40 are preferably formed of steel or stainless steel to thickness of between 25 mm and 50 mm. Alternatively, locking ohms 27, similar to those of FIG. 3B, may be used, in place of plate 40. Bolts 42 may be, for example, trapezic-profile screws, preferably, socket-headed cap screws, of between M10 and M25. it will be appreciated that other materials and dimensions may similarly be used.

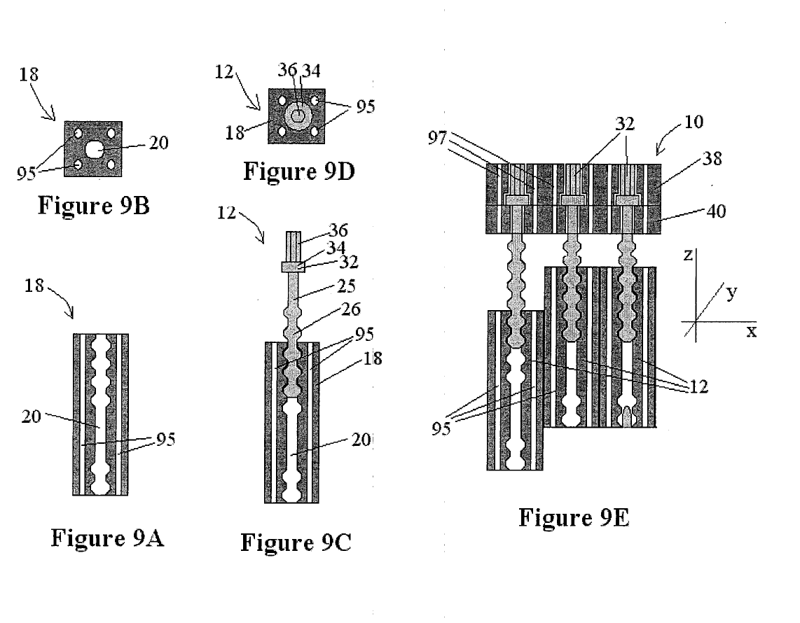

FIGS. 9A-9E schematically through channels for mold injection, for temperature control, such as cooling or heating, and for wiring and housing of various sensors, in accordance with a preferred embodiment of the present invention.

FIGS. 9A and 9B illustrate cross-sectional side and top views of pin body 18 with through channels 95.

FIGS. 9C and 9D illustrate cross-sectional side and top views of pin 12 with through channels 95.

FIG. 9E illustrates a cross-sectional side view of assembly 10 with through channels 95 in pins 12 and corresponding through channels 97 in plates 38 and 40.

It will be appreciated that more of fewer through channels 95 may be designed, for example, one, two, or six per pin body 18, or only in a few of pin bodies 18, or any other combination, as needed.

It will be further appreciated that inner cavity 20, defining lumen 20, need not be at the center of pin body 18.

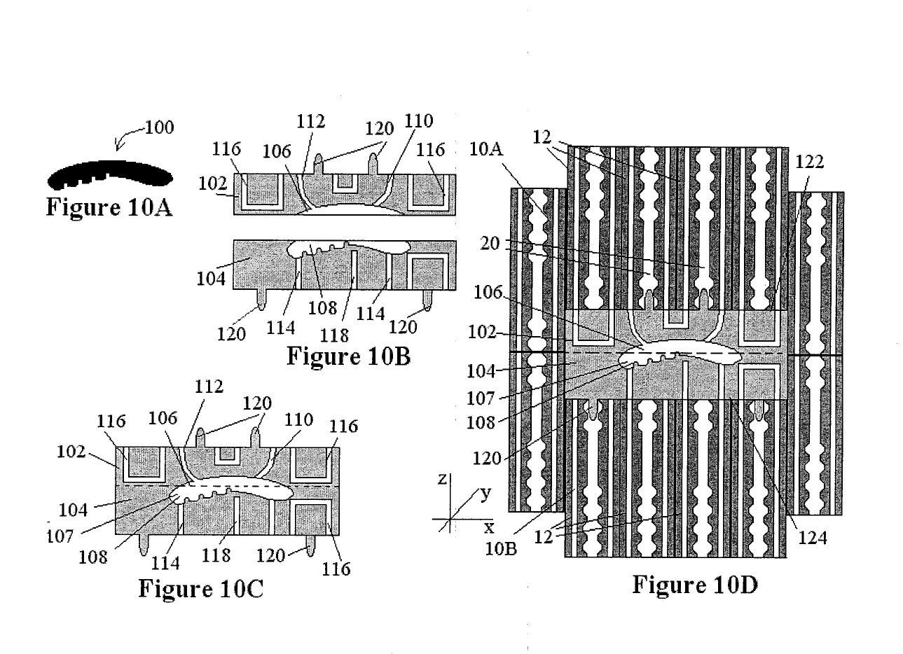

Referring further to the drawings, FIGS. 10A-10D schematically illustrate a first stage in the injection molding of plastics, in accordance with a preferred embodiment of the present invention.

As seen in FIG. 10A, a plastic product 100, to be produced by injection molding, is desired.

As seen in FIG. 10B, first and second portions 102 and 104 of a mold insert are produced, for example, of cast iron, or alloy steel. First portion 102 defines an inner space 106 and second portion 104 defines an inner space 108.

As seen in FIG. 10C, when abut against each other, inner spaces 106 and 108 form a mold product 107 for plastic product 100.

At least one of first and second portions 102 and 104 includes at least one injection channel 110 and at least one air vent 112. Alternatively, more than one injection channel 110 and more than one air vent 112 may be used.

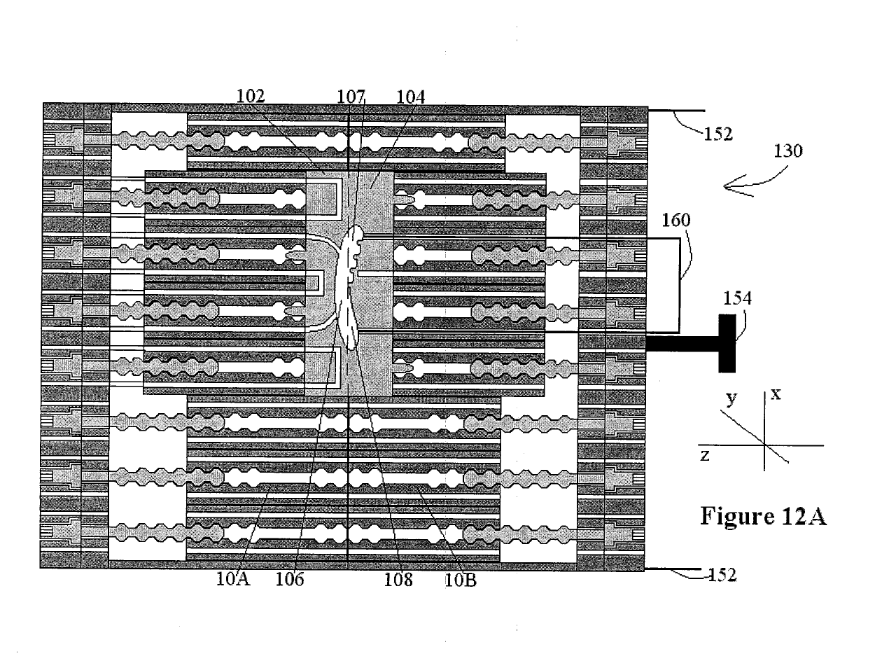

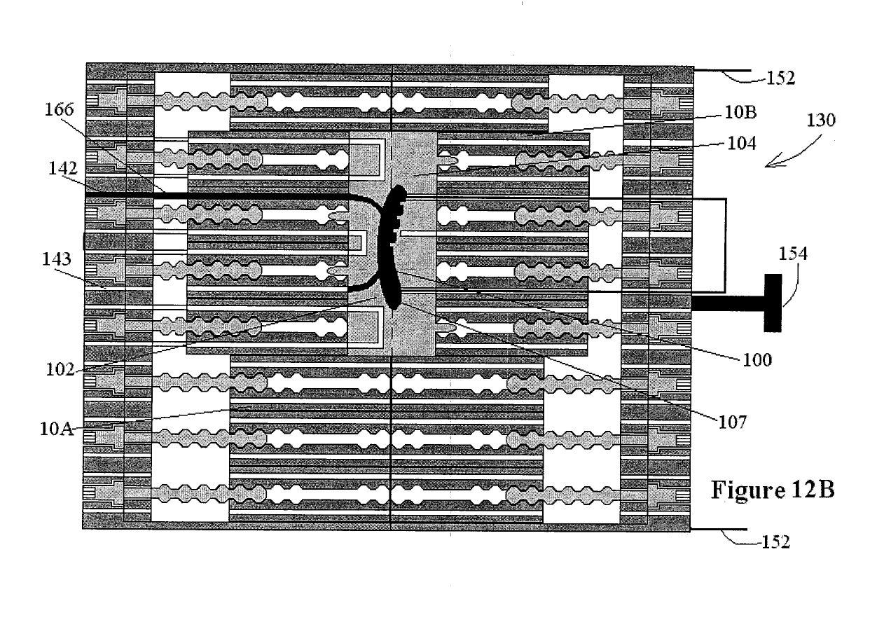

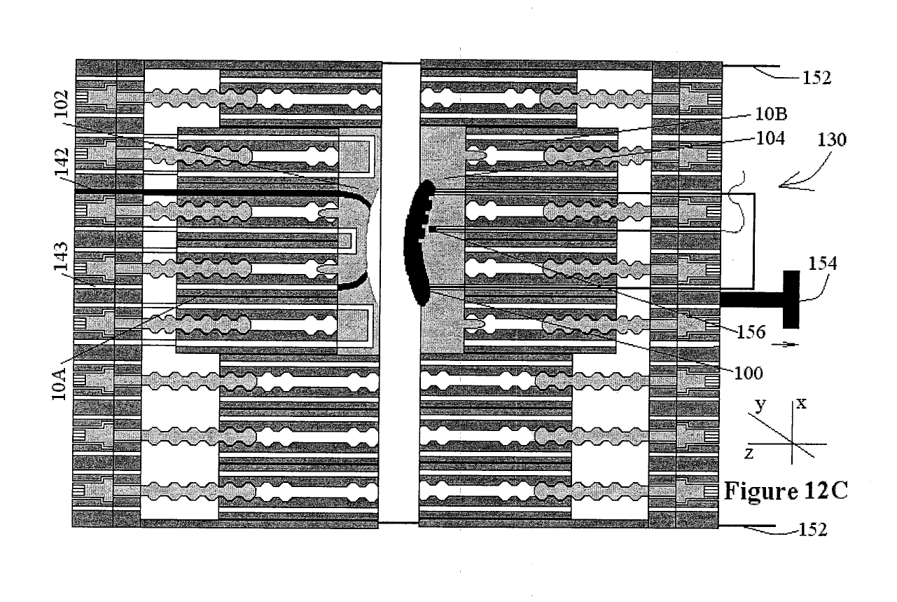

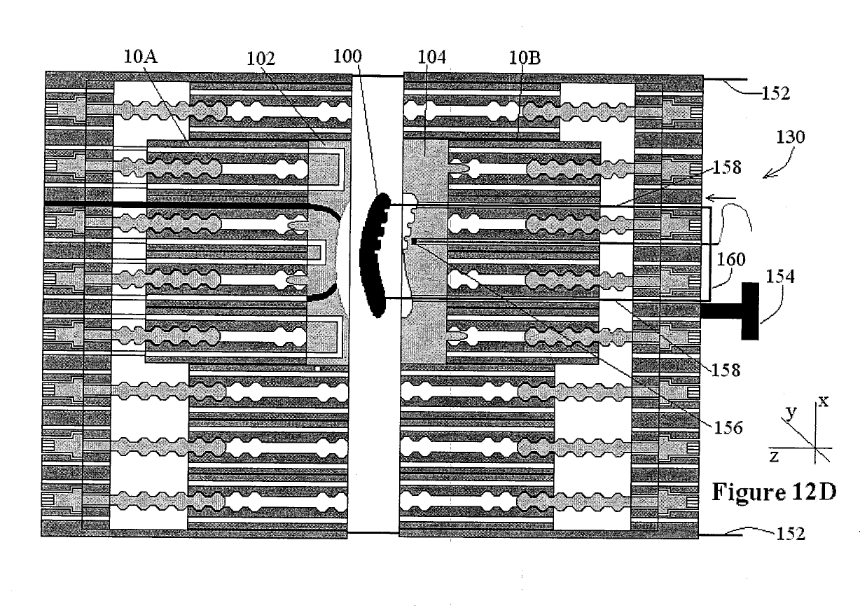

Preferably, at least one of first and second portions 102 and 104 includes at least one ejector channel 114, for ejecting mold 100 (FIG. 10A) when it is formed, as will be described hereinbelow, in conjunction with FIG. 12D.

Furthermore, first and second portions 102 and 104 may include temperature-control channels 116, such as cooling or heating channels 116, which may house cooling or heating pipes as known, or which may be used for Peltier-type cooling or heating, as known. Moreover, first and second portions 102 and 104 may include at least one sensor channel 118, for example, for a temperature sensor, or a pressure sensor.

Additionally, first and second portions 102 and 104 may include alignment pins 120.

FIG. 10D illustrates two pin assemblies 10A and 10B, arranged as mirror image to each other. The +z direction is considered proximal for the two assemblies of the present embodiment.

In assembly 10A, length adjustments to pins 12 form a cavity 122, which is distal-most to pin assembly 10A, and which is adapted to receive first portion 102 of the mold insert.

In assembly 10B, length adjustments to pins 12 form a cavity 124, which is proximal-most to pin assembly 10B, under the present arrangement, and which is adapted to receive second portion 104 of the mold insert.

When first and second mold inserts 102 and 104 are placed in cavities 122 and 124 of pin assemblies 10A and 10B, the various channels that are carved in first and second mold inserts 102 and 104 are aligned with channels 95 of pins 12. Additionally, alignment pins 120 may be aligned with lumens 20 or with channels 95 of pins 12.

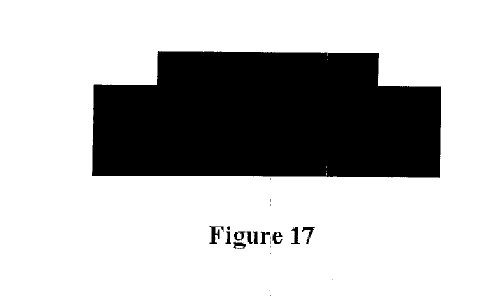

It will be appreciated that a plastic mold may be formed directly, without mold inserts 102 and 104, as will be described hereinbelow, in conjunction with FIG. 17.

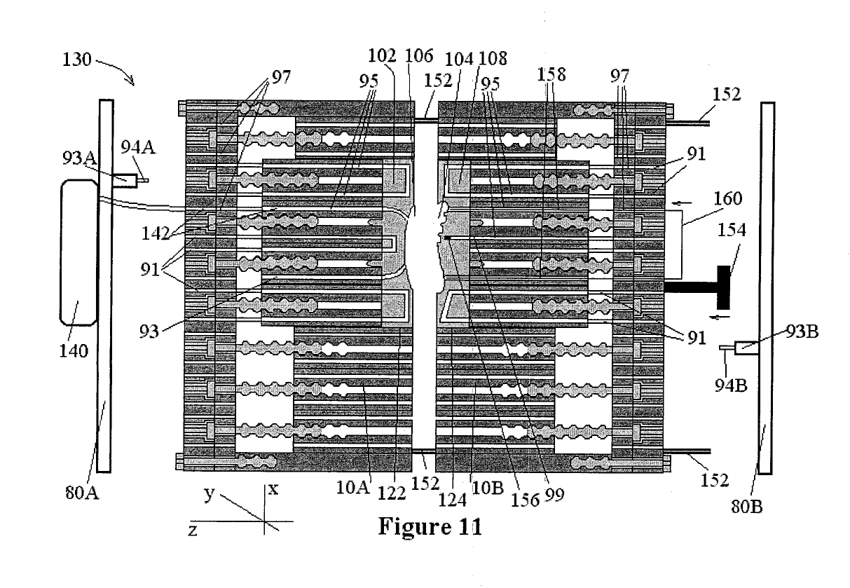

Referring further to the drawings, FIG. 11 schematically illustrates an injection-molding press 130 for injection molding of plastics, in accordance with a preferred embodiment of the present invention.

Injection-molding press 130 defines an x;y;z coordinate system, and a proximal direction in the +z direction. Injection-molding press 130 comprises first and second pin assemblies 10A and 10B, arranged as mirror image to each other, and defining inner cavities 122 and 124 therein, for housing first and second mold inserts 102 and 104. When first and second pin assemblies 10A and 10B are abut against each other, inner spaces 106 and 108 form mold product 107 (FIG. 10C) for plastic product 100 (FIG. 10A).

Additionally, injection-molding press 130 includes a first gantry system 80A, similar to gantry system 80 of FIGS. 5A-5C, and including a first tool support 93A, having a first tool 94A, for controlling the positions of pins 12 of first pin assembly 10A. Additionally, injection-molding press 130 may further include a second gantry system 80B, similar to gantry system 80A and including a second tool support 93B, having a second tool 94B, for controlling the positions of pins 12 of second pin assembly 10B.

Alternatively, at least one gantry system may be used, in communication with either first pin assembly 10A or second pin assembly 10B.

Furthermore, injection-molding press 130 includes an injection system 140, preferably adapted for injection molding for plastics, preferably arranged in fluid communication with first mold insert 102, in inner cavity 122, through at least one injection channel 142, which run inside channels 95 and 97, in first pin assembly 10A. Additionally, two or more injection channels 142 may be used. Another channel 95 may be operative as an air vent channel 93. Additionally or alternatively, injection system 140 may be arranged for communication with second mold insert 104 in second pin assembly 10B.

In accordance with an embodiment of the present invention, injection system 140 and first gantry system 80A may be integrated. Additionally or alternatively, injection system 140 and second gantry system 80B may be integrated.

Moreover, injection-molding press 130 may include temperature-control channels 91, such as cooling or heating channels 91, which run inside channels 95 and 97. Channels 91 may be used for the circulation of a coolant or a heating fluid. Alternatively, Peltier-type cooling or heating may be used in channels 91, or directly in channels 95.

Injection-molding press 130 may further include one, or two or more sensors 156 such as temperature and pressure sensors, which may be wired through a sensor channel 99, which run inside channels 95 and 97.

Injection-molding press 130 may further include at least one, and preferably two or more ejectors 158, on an ejector gantry 160, for ejecting mold 100 (FIG. 10A) when it is formed, as will be described hereinbelow, in conjunction with FIG. 12D.

Preferably, first pin assembly 10A is stationary, while second pin assembly 10B is mounted on a press gantry 152, and adapted for motion in the ±z direction, for example, as tracks 152.

Additionally, motion of second pin assembly 10B is provided by a pressure applicator 154, capable of producing a pressure of between 20 tons and 15,000 tons.

As pressure applicator 154 brings first and second pin assemblies 10A and 10B abut, first and second portions of mold insert 102 and 104 come together and first and second inner spaces 106 and 108 form mold product 107, under the desired pressure.

Referring further to the drawings, FIGS. 12A-12, together, schematically illustrate the process of injection molding in accordance with a preferred embodiment of the present invention.

As seen in FIG. 12A, assembly 10B is moved proximally, so as to abut against assembly 10A, under pressure, by pressure applicator 154.

As seen in FIG. 12B, a mold liquid 166 is injected via injection channel 142, to form product 100.

As seen in FIG. 12C, assembly 10B is moved distally, away from assembly 10A, with product 100 preferably remaining on assembly 10B. The timing for moving assembly 10B may be determined by sensor 156 near mold product 100.

As seen in FIG. 12D, gantry 160 moves ejectors 158 in the +z direction, so as to eject product 100. The timing for ejecting product 100 may be determined by sensor 156 near mold product 100.

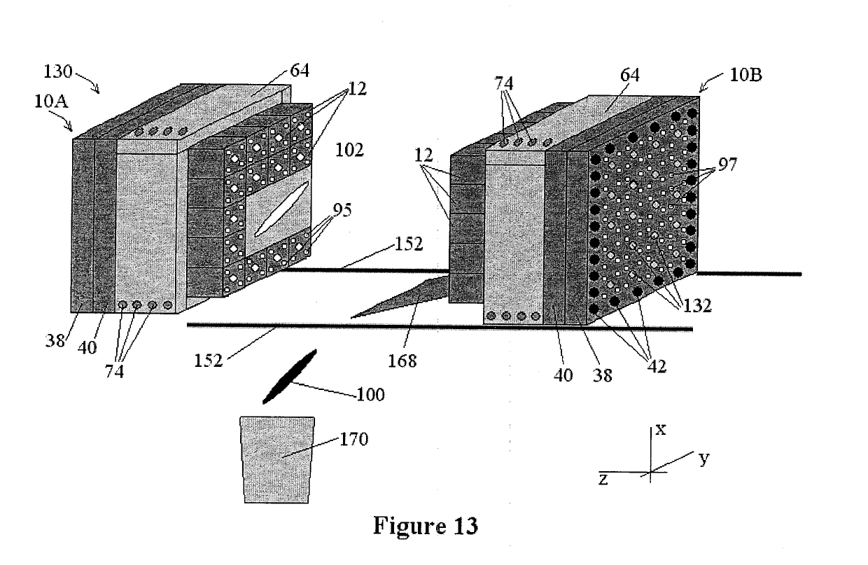

Referring further to the drawings, FIG. 13 is a schematic, pictorial representation of injection-molding press 130, in accordance with a preferred embodiment of the present invention.

A tray 168 may be provided for guiding ejected product 100 to a bucket 170.

Sidewalls 64 may be provided, on assemblies 10A and 10B, bolted with bolts 74. Sidewalls 64 may extend the lengths of pins 12 or part of their lengths.

Plates 38 and 40 are preferably formed of steel or stainless steel to thickness of between 25 mm and 50 mm. Alternatively, locking ohms 27, similar to those of FIG. 3B, may be used, in place of plate 40. Bolts 42 (FIG. 8D) and 74 are preferably formed of stainless steel and have diameters and threads which are similar to those of screw 25, for example, they may be trapezic-profile screws, preferably, socket-headed cap screws, of between M10 and M25. Sidewalls 64 are preferably formed of stainless steel, to a thickness of between 25 mm and 50 mm.

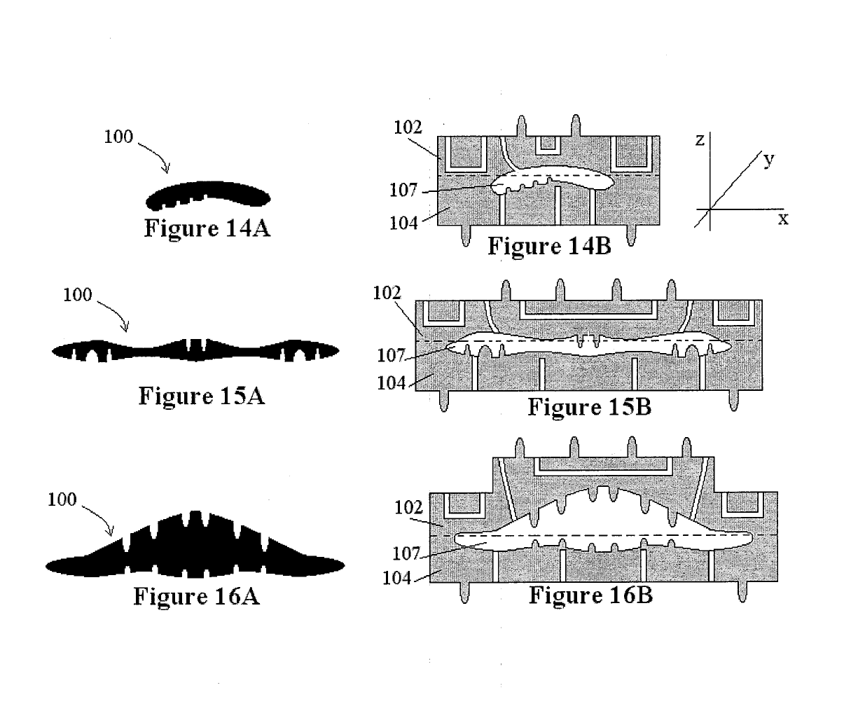

FIGS. 14A-14B schematically illustrate a first product 100 which may be molded by first and second insert portions 102 and 104, and injection-molding press 130 of the present invention.

FIGS. 15A-15B schematically illustrate a second product 100 which may be molded by first and second insert portions 102 and 104, and injection-molding press 130 of the present invention.

FIGS. 16A-16B schematically illustrate a third product 100 which may be molded by first and second insert portions 102 and 104, and injection-molding press 130 of the present invention. It will be appreciated that there need not be any symmetry to insert portions 102 and 104, in any of the x, y, and z directions.

Referring further to the drawings, FIG. 17 schematically illustrates a plastic mold product 107, formed directly, without mold inserts 102 and 104. Injection-molding press 130 of the present invention is designed to withstand temperatures of 400° C. and pressures of between about 250 and about 11000 tons. Preferably, injection-molding press 130 of the present invention is further designed to withstand pressures of about 15000 tons.

As used herein the term “about” refers to ±30%.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination. Furthermore, although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. Citations of any reference in this application shall not be construed as an admission that such reference is available as prior art to the present invention.

What is claimed is:

1. A pin of an adjustable length, comprising:
an x;y;z coordinate system;
proximal and distal ends, with respect to an operator, defining +z and −z directions, respectively;
a screw, aligned with the z axis, and including:
a proximal portion, formed as a head, adapted to engage with a tool, for turning said screw, and adapted to engage with a locking mechanism, for preventing motion of said screw in the ±z direction, as said screw turns; and
a distal portion, formed as a stem, which issues from said head and which is threaded at least along part of its length; and
a pin body, aligned with the z axis, said pin body defining an inner cavity, having a threaded portion, adapted for threaded communication with said stem, wherein as said screw is turned in a first direction, into said pin body, the length of said pin along the z axis is shortened, and as said screw is turned in the reverse direction, the length of said pin is increased,
wherein said pin is adapted to withstand a pressure of at least 20 tons.

2. The pin of claim 1, adapted to withstand a pressure of at least 100 tons.

3. The pin of claim 1, adapted to withstand a pressure of at least 500 tons.

4. The pin of claim 1, adapted to withstand a pressure of at least 1000 tons.

5. The pin of claim 1, adapted to withstand a pressure of at least 5000 tons.

6. The pin of claim 1, adapted to withstand a pressure of at least 10000 tons.

7. The pin of claim 1, adapted to withstand a pressure of at least 12000 tons.

8. The pin of claim 1, adapted to withstand a pressure of at least 15000 tons.

9. The pin of claim 1, adapted for temperatures of 400° C.

10. The pin of claim 1, wherein said pin further includes at least one through channel, operable for injection of a molding substance.

11. The pin of claim 1, wherein said pin further includes at least one through channel, operable for temperature control.

12. The pin of claim 1, wherein said pin further includes at least one through channel, operable for housing at least one sensor.

13. The pin of claim 1, wherein said inner cavity is a lumen, which runs the length of said pin body.

14. A pin assembly, comprising:
an x;y;z coordinate system;
proximal and distal ends, with respect to an operator, defining +z and −z directions, respectively;
an array of pins of adjustable lengths, having m by n pins, wherein both m and n are integers, each individually selected from the group consisting of 1, 2, and integers greater than 2, and wherein each pin comprises:
a screw, aligned with the z axis, and including:
a proximal portion, formed as a head, adapted to engage with a tool, for turning said screw, and adapted to engage with a locking mechanism, for preventing motion of said screw in the ±z direction, as said screw turns; and
a distal portion, formed as a stem, which issues from said head and which is threaded at least along part of its length; and
a pin body, aligned with the z axis, said pin body defining an inner cavity, having a threaded portion, adapted for threaded communication with said
stem, wherein as said screw is turned in a first direction, into said pin body, the length of said pin along the z axis is shortened, and as said screw is turned in the reverse direction, the length of said pin is increased; and
said locking mechanism, adapted for engagement with said screw heads, for preventing motion of said screws in the ±z direction, as said screws turn, wherein said pin assembly is adapted to withstand a pressure of at least 20 tons.

15. The pin assembly of claim 14, wherein said locking mechanism includes:
a first plate, on the proximal side of, and abut against said screw heads, for preventing any of said screws from moving proximally;
a second plate, on the distal side of and abut against said screw heads, for preventing any of said screws from moving distally; and
bolts for holding said first and second plates together.

16. The pin assembly of claim 14, wherein said locking mechanism includes:
a first plate, on the proximal side of, and abut against said screw heads, for preventing any of said screws from moving proximally; and
locking ohms, arranged on said screws, on the distal side of and abut against said screw heads, for preventing said screws from moving distally.

17. The pin assembly of claim 14, wherein said array further includes sidewalls, which are bolted to each other, in a direction selected from the group consisting of clockwise and counterclockwise directions, for pressing said pins tightly to each other.

18. The pin assembly of claim 14, wherein said array of pins may be selectively disassembled and rearranged into a different array.

19. The pin assembly of claim 14, adapted to withstand a pressure of at least 100 tons.

20. The pin assembly of claim 14, adapted to withstand a pressure of at least 500 tons.

21. The pin assembly of claim 14, adapted to withstand a pressure of at least 1000 tons.

22. The pin assembly of claim 14, adapted to withstand a pressure of at least 5000 tons.

23. The pin assembly of claim 14, adapted to withstand a pressure of at least 10000 tons.

24. The pin assembly of claim 14, adapted to withstand a pressure of at least 12000 tons.

25. The pin assembly of claim 14, adapted to withstand a pressure of at least 15000 tons.

26. The pin assembly of claim 14, adapted for temperatures up to 400° C.

27. The pin assembly of claim 14, wherein at least one of said pins further includes at least one through channel, operable for injection of a molding substance.

28. The pin assembly of claim 14, wherein at least one of said pins further includes at least one through channel, operable for temperature control.

29. The pin assembly of claim 14, wherein at least one of said pins further includes at least one through channel, operable for housing at least one sensor.

30. The pin assembly of claim 14, wherein at least one of said pins includes a plurality of through channels.

31. The pin assembly of claim 14, adapted for the production of insole molds.

32. The pin assembly of claim 14, adapted for the production of packaging materials.

33. An injection molding press, comprising:
a first, stationary pin assembly, which includes:
an x;y;z coordinate system;
proximal and distal directions, defined as +z and −z directions, respectively;
a first array of pins of adjustable lengths, having m1 by n1 pins, wherein both m1 and n1 are integers, each individually selected from the group consisting of 1, 2, and integers greater than 2;
a first tool, mounted on a first gantry on the proximal side of said first pin assembly, for adjusting the lengths of said pins of said first pin assembly, so as to form a distal-most cavity, therein; and
an injection system, external to said first pin assembly and in liquid communication with said distal-most cavity, through at least one channel, arranged along at least one pin; and
a pressure applicator, capable of producing a pressure of at least 20 tons, said pressure applicator comprising:
a press gantry, which provides movement in the ±z direction;
a second pin assembly, comprising a second array of m2 by n2 of said pins, wherein both m2 and n2 are integers, each individually selected from the group consisting of 1, 2, and integers greater than 2, and wherein said second array is constructed in a manner analogous to said first array, but arranged as mirror image across the x;y plane, to said first array, on said press gantry;
a second tool, mounted on a second gantry on the distal side of said second pin assembly, for adjusting the lengths of said pins of said second pin assembly, so as to form a proximal-most cavity, therein;
wherein as said pressure applicator brings said first and second pin assemblies abut, under pressure, said first and second pin assemblies form an inner space, within which a mold product forms, under said pressure.

34. The injection molding press of claim 33, wherein each pin of said first, stationary pin assembly comprises:
a screw, aligned with the z axis, and including:
a proximal portion, formed as a head, adapted to engage with a tool, for turning said screw, and adapted to engage with a locking mechanism, for preventing motion of said screw in the ±z direction, as said screw turns; and
a distal portion, formed as a stem, which issues from said head and which is threaded at least along part of its length; and
a pin body, aligned with the z axis and having a distal-most surface, said pin body defining an inner cavity, having a threaded portion, adapted for threaded communication with said stem, wherein as said screw is turned in a first direction, into said pin body, a length of said pin along the z axis is shortened, and as said screw is turned in the reverse direction, the length of said pin is increased; and
said locking mechanism, adapted for engagement with said screw heads, for preventing motion of said screws in the ±z direction, as said screws turn.

35. The injection-molding press of claim 33, and further including placing first and second insert portions, in said distal-most and proximal-most inner spaces.

36. The injection-molding press of claim 33, wherein said second pin assembly further includes at least one mold ejector, arranged in at least one channel within said pins, for providing travel into said second inner space, for ejecting said mold.

37. The injection-molding press of claim 33, wherein said second pin assembly further includes at least two mold ejectors, arranged in channels within said pins, for providing travel into said second inner space, for ejecting said mold.

38. The injection-molding press of claim 33, wherein said injection system includes at least two channels, arranged in said first pin assembly, for providing liquid communication with said first portion of mold insert.

39. The injection-molding press of claim 33, wherein said first pin assembly further includes sidewalls, which are bolted to each other, in a direction selected from the group consisting of clockwise and counterclockwise directions, for pressing said pins tightly to each other.

40. The injection-molding press of claim 33, wherein said second pin assembly further includes sidewalls, which are bolted to each other, in a direction selected from the group consisting of clockwise and counterclockwise directions, for pressing said pins tightly to each other.

41. The injection-molding press of claim 33, wherein said first array of pins may be selectively disassembled and rearranged into a different array.

42. The injection-molding press of claim 33, wherein said second array of pins may be selectively disassembled and rearranged into a different array,

43. The injection-molding press of claim 33, adapted to withstand a pressure of at least 20 tons.

44. The injection-molding press of claim 33, adapted to withstand a pressure of at least 100 tons.

45. The injection-molding press of claim 33, adapted to withstand a pressure of at least 500 tons.

46. The injection-molding press of claim 33, adapted to withstand a pressure of at least 1000 tons.

47. The injection-molding press of claim 33, adapted to withstand a pressure of at least 5000 tons.

48. The injection-molding press of claim 33, adapted to withstand a pressure of at least 10000 tons.

49. The injection-molding press of claim 33, adapted to withstand a pressure of at least 12000 tons.

50. The injection-molding press of claim 33, adapted to withstand a pressure of at least 15000 tons.

51. The injection-molding press of claim 33, adapted for temperatures of 400° C.

52. The injection-molding press of claim 33, wherein said press further includes temperature-control channels, arranged within said pins.

53. The injection-molding press of claim 33, wherein said press further includes at least one channel, arranged within said pins, for housing at least one sensor.

54. A method of plastic injection molding comprising:
providing an injection molding press, comprising:
a first, stationary pin assembly, which includes:
an x;y;z coordinate system;
proximal and distal directions, defined as +z and −z directions, respectively;
a first array of pins of adjustable lengths, having m1 by n1 pins, wherein both m1 and n1 are integers, each individually selected from the group consisting of 1, 2, and integers greater than 2;
a first tool, mounted on a first gantry on the proximal side of said first pin assembly, for adjusting the lengths of said pins of said first pin assembly, so as to form a distal-most cavity, therein; and
an injection system, external to said first pin assembly and in liquid communication with said distal-most cavity, through at least one channel, arranged along at least one pin; and
a pressure applicator, capable of producing a pressure of at least 20 tons, said pressure applicator comprising:
a press gantry, which provides movement in the ±z direction;
a second pin assembly, comprising a second array of m2 by n2 of said pins, wherein both m2 and n2 are integers, each individually selected from the group consisting of 1, 2, and integers greater than 2, and wherein said second array is constructed in a manner analogous to said first array, but arranged as mirror image across the x;y plane, to said first array, on said press gantry; and
a second tool, mounted on a second gantry on the distal side of said second pin assembly, for adjusting the lengths of said pins of said second pin assembly, so as to form a proximal-most cavity, therein;
arranging pins of at least one of said first and second pin arrays, to form at least one cavity;
bringing said first and second pin assemblies together, by said pressure applicator, thus forming an inner space therein, and applying pressure thereto;
injecting the plastic fluid to said inner space, under said pressure;
separating said first and second pin assemblies, by said pressure applicator; and
ejecting a plastic mold product, formed within said inner space.

55. The method of plastic injection molding of claim 54, and further including placing first and second insert portions, in said distal-most and proximal-most inner spaces.
